(19) United States
(12) Patent Application Publication
(10) Pub. No.: US 2006/0104760 A1
(43) Pub. Date: May 18, 2006

(54) Lift platform having retractable barrier

(76) Inventors: Kevin Cecil, Orlando, FL (US); Chad McCoige, Orlando, FL (US)

Correspondence Address: Janine A. Moderson;Pauley Petersen & Erickson, Suite 365, 2800 West Higgins Road, Hoffman Estates, IL, 60195, US

(21) Appl. No.: 11/254,326

(22) Filed: Oct. 20, 2005

Related U.S. Application Data
(60) Provisional application No. 60/623,276, filed on Oct. 29, 2004.
(60) Provisional application No. 60/622,089, filed on Oct. 26, 2004.

(51) Int. Cl. B65G 67/00

(52) U.S. Cl. 414/399

(57) ABSTRACT

A loading device for lifting and loading cargo onto aircraft includes a support frame and at least one lift platform that can be raised and lowered relative to the support frame. A retractable barrier is provided between the lift platform and the support frame to provide a physical and visual cue to impede or discourage persons from intruding into dangerous areas of the loading device during raised operation.

### FIELD OF THE INVENTION

This invention relates to a loading device used for lifting and loading cargo onto aircraft, and for unloading cargo from the aircraft. The loading device includes at least one lift platform that can be raised and lowered. The lift platform is equipped with a retractable barrier that serves as a physical and visual cue to impede or discourages persons from intruding into dangerous areas of the loader when the platform is raised.

### BACKGROUND OF THE INVENTION

Various loading devices for loading cargo onto aircraft, and unloading cargo from aircraft, are known. These devices are typically operated by experienced personnel who are accustomed to the risks of operating heavy equipment, and the precautions that must be taken. However, today's airports become very busy and there is tremendous pressure on airlines to maintain flight schedules. Cargo loaders are often operated in an environment that includes maintenance personnel, baggage handlers and other persons working together to prepare for the next flight. In such an environment, there is always a need or desire for safety devices which prevent or reduce the likelihood of accidents.

### SUMMARY OF THE INVENTION

The present invention is directed to a loading device having a hazard zone within a perimeter of the loading device. The loading device includes at least a support frame, a lifting mechanism connected to the support frame, and a movable lift platform supported by the support frame and engaging the lifting mechanism. A retractable flexible barrier is connected at one end to the support frame, and at an opposing end to the movable lift platform, and spans at least a portion of the distance between the support frame and the lift platform. The support frame and lift platform may each have a rectangular shape with four edges. The flexible barrier is positionable adjacent the hazard zone, and is connected to at least one edge of the support frame and a corresponding edge of the lift platform, to prevent or discourage persons, appendages or equipment from intruding into the hazard zone underneath the lift platform when the latter is raised. For additional protection, the same flexible barrier, or additional flexible barriers, can be connected to additional edges of the support frame and corresponding edges of the lift platform.

With the foregoing in mind, it is a feature and advantage of the invention to provide a loading device equipped with at least one flexible barrier to prevent or discourage accidents during operation.

### BRIEF DESCRIPTION OF THE DRAWINGS

FIG. 1 is a perspective view of a loading device of the invention;

FIG. 2 is a perspective view of a loading device as shown in FIG. 1, without some of the internal features, to better illustrate the external features;

FIG. 3A illustrates a spring-loaded roller device for rolling and unrolling a flexible barrier used in a loading device such as in FIGS. 1 and 2;

FIG. 3B is a partial cutaway view of the roller device of FIG. 3, showing its internal features;

FIG. 3C is an exploded view of the roller device of FIG. 3;

FIG. 4 illustrates an electronic safety device which can be used to shut down the loading device if a flexible barrier is violated.

### DETAILED DESCRIPTION OF THE EXEMPLARY EMBODIMENTS

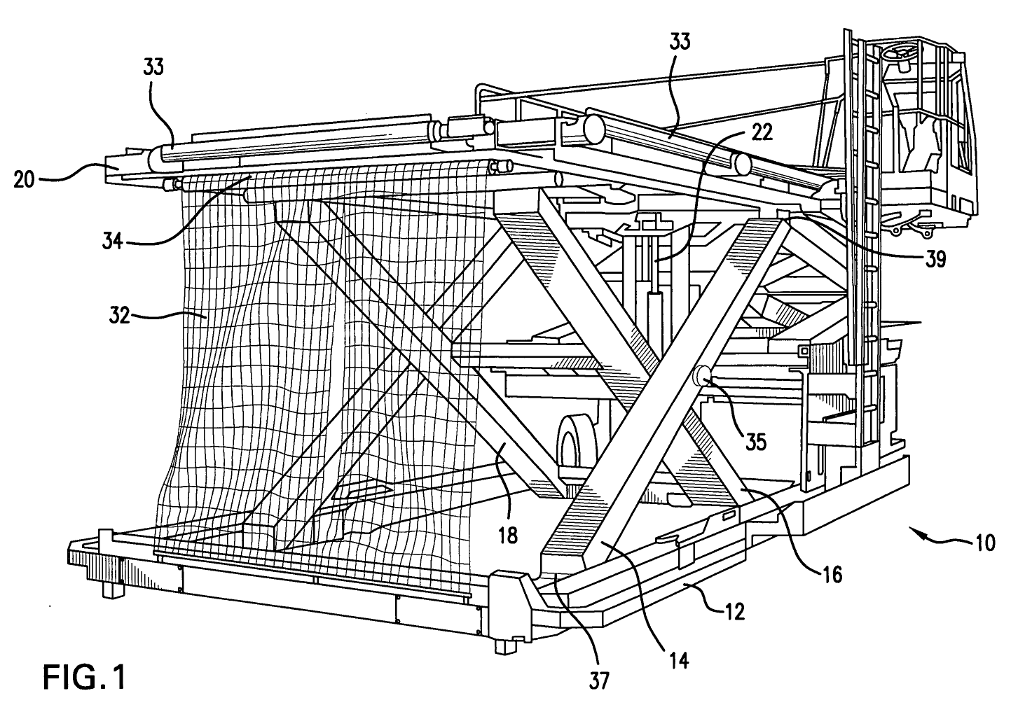

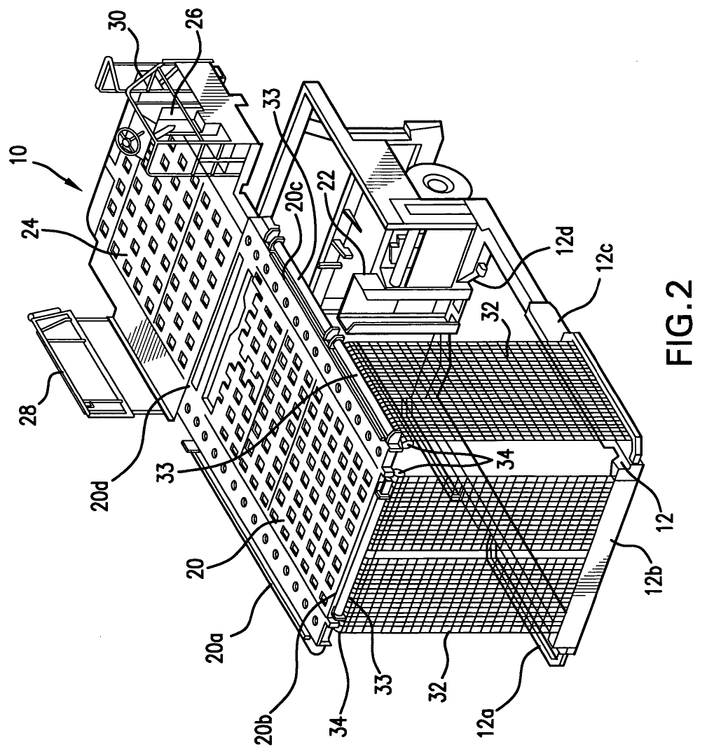

Referring to FIGS. 1 and 2, a loading device 10 includes a support frame 12, a lifting mechanism 14 represented in the exemplary embodiment by scissors 16 and 18, a movable lift platform 20, and a bridge 24 with an operator station 26 and rails 28 and 30. It is known to those skilled in the art that the bridge 24 may also be a lift platform useable in conjunction with lift platform 20. Bridge 24 may be referred to in the field of art as an operator platform, a forward platform, or an aircraft interface platform, among other names. The exemplary support frame 12 is rectangular, and has four side edges 12a, 12b, 12c and 12d. The exemplary lift platform 20 is rectangular, and has four side edges 20a, 20b, 20c and 20d. Alternatively, the support frame and/or the lift platform may be any shape having multiple edges suitable for loading and/or unloading cargo including, but not limited to, triangular, square, pentagonal, hexagonal and octagonal. The platform 20 is raised and lowered by a lifting mechanism 22 which is controlled from operator station 26.

As shown in FIG. 2, when the lift platform 20 is in a raised position, at least one retractable barrier 32 is connected to the end edge 12b of the support frame 12 and to the end edge 20b of the lift platform 20. The retractable barrier 32 may be a flexible screen, fence, or chain link net having an open structure to permit passage of wind. The flexible barrier 32 may be formed of nylon or other plastic yarn, metal wire, rope, or any suitable material that is flexible and can be formed into a planar barrier. In the exemplary embodiment, a mesh is used in order to permit wind to pass through the barrier. As the platform 20 is lowered and raised, the barrier 32 is wound and unwound from a tubular winder 34, which may be connected to the end edge 20b of the platform 20 behind and/or under a standard cargo loader roller 33. Alternatively, the tubular winder 34 may be attached to the end edge 12b of the support frame 12. Other attachment configurations may also be employed that provide a suitable securement for tubular winder 34, allowing positioning of barrier 32 along the perimeter of or adjacent to the zone of operational hazards.

As will be apparent from FIG. 2, additional barriers 32 and tubular winders 34 can be attached to side edge 12a of support frame 12 and side edge 20a of platform 20, to side edge 12c of support frame 12 and side edge 20c of platform 20, and/or to front edge 12d of support frame 12 and front edge 20d of platform 20. The precise positioning and mounting configuration that place barrier 32 along the perimeter of or adjacent to the hazard zone may depend on specific characteristics of a particular loading device. Suitably, the barrier 32 may be positionable inside of the hazard zone or outside of the hazard zone. The retractable barriers 32 prevent or discourage persons from intruding into the space between platform 20 and support frame 12 during use of loading device 10. During operation, the area generally under platform 20 and around the components of the lifting mechanism 22 become a dangerous crush area or operational hazard zone, where the potential exists that persons, appendages and equipment can be harmed by the immense forces of the hydraulic equipment, as well as the weight of any cargo. Some examples of dangers in the crush area include the scissors 16 and 18 that create multiple pressure points capable of ensnaring, pinching and crushing clothing and body parts. Such pressure points exist at the pivotal crossover points 35 of the scissors, at the pivotal connection points 37 between the scissors and the support frame 12, and at the pivotal connection points 39 between the scissors and the lift platform 20. Other pressure points of the crush area exist between the platform 20 and the support frame 12, as the platform 20 is lowered. The retractable barriers 32 provide a physical and visual reminder that helps to protect workers and bystanders from inadvertent exposure to the crush area and these pressure points as the platform is moved between its minimum height, where platform 20 is lowered to a position near support frame 12 and its maximum height, where platform 20 is completely extended away from support frame 12.

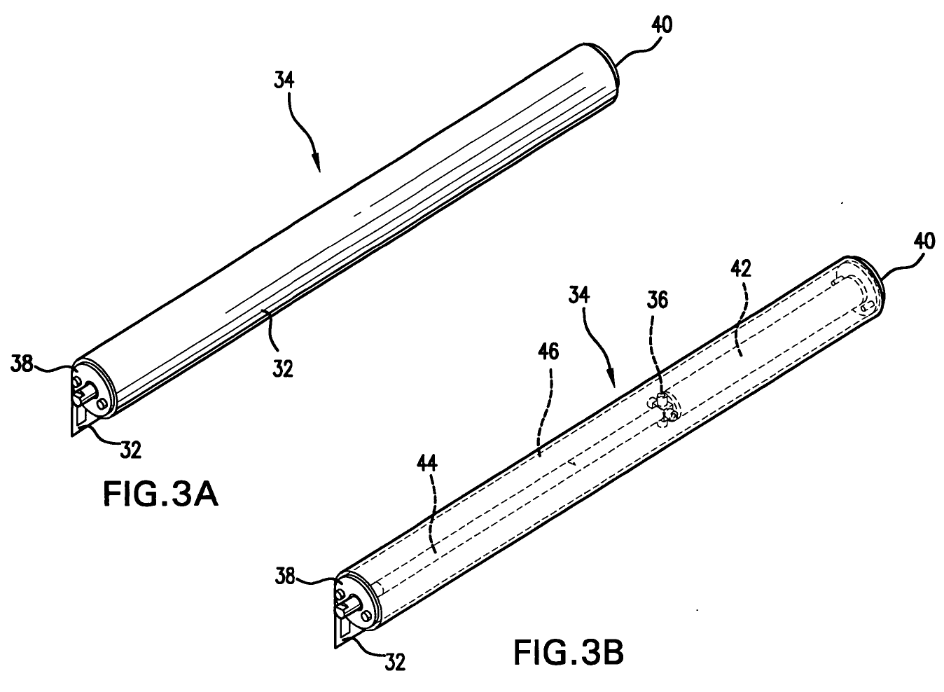

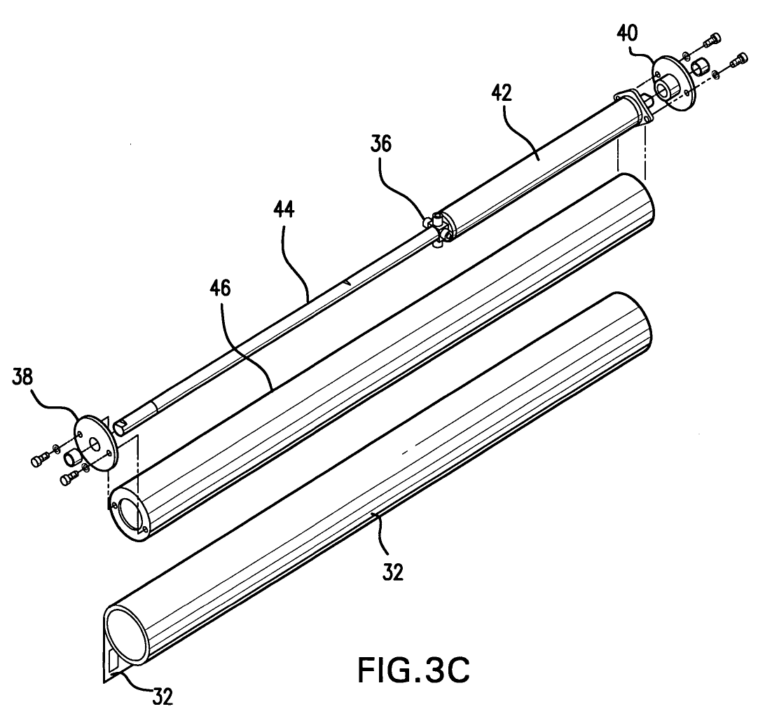

Referring to FIGS. 3A, 3B and 3C, each tubular winder 34 may include a hollow tube 46 and a spring-loaded drive mechanism 36 mounted to inside end caps 38 and 40 of the tube 46. The spring-loaded drive mechanism 36 includes a rotatable spring 42 connected to a fixed mounting shaft 44, which in turn is mounted to end caps 38 and 40. As the lift platform 20 is raised, the barrier 32 is unwound against the force of the spring 42. As the lift platform 20 is lowered, the barrier 32 is wound around the winder 34 which rotates with the aid of spring 36.

In the embodiment shown in FIGS. 1 and 2, each flexible barrier 32 is connected at one end to the winder 34, which in turn is mounted to an edge (e.g. 20b or 20c) of lift platform 20. Each flexible barrier 32 is connected at its other end to a corresponding edge (e.g. 12b or 12c) of frame 12. The latter connection may be permanent, but is advantageously a removable, non-permanent connection. The advantage of a removable, non-permanent connection is that the flexible barrier 32 may be disengaged when there is a need to enter the space between lift platform 20 and support frame 12.

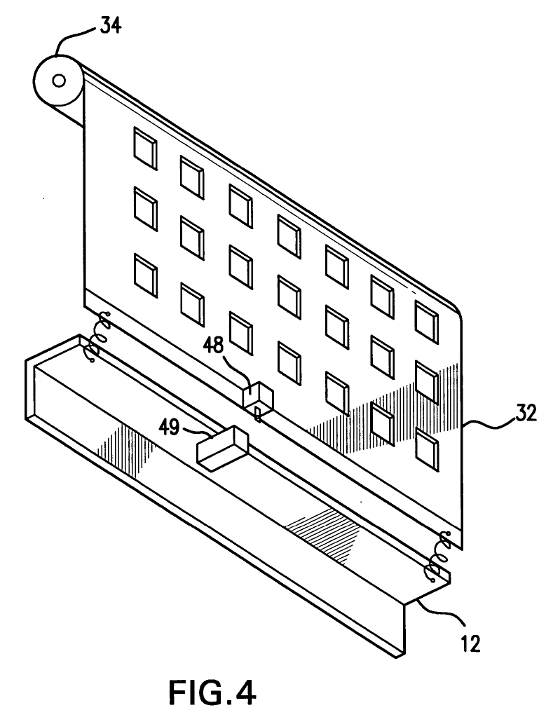

On the other hand, it is useful to provide a warning signal and/or shut-off device which is activated automatically when the flexible barrier 20 becomes disengaged from the support frame 12. FIG. 4 illustrates the use of an electronic switch 48 mounted to the flexible barrier 32. When the flexible barrier 32 is connected to the support frame 12, the electronic switch is pressed against an engaging member 49 mounted to the frame 12, and is maintained in an “on” position. When the flexible barrier 32 becomes disengaged from the frame 12, the switch 48 disengages from the member 49 and automatically reverts to an “off” position, causing the loading device 10 to shut down. The lift platform 20 is thus prevented from being raised or lowered when the flexible barrier 32 is disconnected from the frame 12. A similar switch may be mounted relative to the lift platform, and activated if the flexible barrier becomes disengaged from the lift platform.

Other features of the loading apparatus are illustrated. As shown in FIG. 2, the lift platform 20 can be raised to the same height as the operating platform 24, in order to facilitate transport of cargo from the lift platform by persons on the operating platform. It would be apparent to one skilled in the art that just as the retractable barrier may be installed onto lift platform 20 it may also be installed on operator platform 24, or on a combination of both lift platform 20 and operator platform 24, in order to provide a physical and visual signal of the boundary of the hazardous crush area. The loading device 10 is self-propelled by conventional equipment features and techniques.

In an alternate embodiment, not shown, but deductively evident by FIGS. 1 and 2, a narrow barrier 32, having a correspondingly shorter tubular winder 34, may be installed at a diagonal, positioned at a corner of two edges of lift platform 20 and frame 12, e.g., corresponding corners 20b-20c and 12b-12c. In this fashion protection may be added to a lifting device's 10 corner, where side barriers 32 may not extend all the way into the corner.

While the embodiments of the invention described herein are illustrative and explanatory of the invention, various modifications and improvement can be made without departing from the spirit and scope of the invention. Furthermore, no limitations are intended by the details of construction or design if the exemplary embodiments shown, other than as described in the claims below. The scope of the invention is defined by the appended claims, and all changes that fall within the meaning and range of equivalents are intended to be embraced therein.

We claim:

1. A loading device, comprising:
a support frame;
a lifting mechanism connected to the support frame;
a movable lift platform engaging the lifting mechanism; and
a retractable barrier mounted to at least one of the lift platform and the support frame, and adapted to engage the other of the lift platform and the support frame.

2. The loading device of claim 1, wherein the retractable barrier is mounted to the lift platform.

3. The loading device of claim 2, wherein the retractable barrier is removably connectable to the support frame.

4. The loading device of claim 1, wherein the retractable barrier is mounted to the support frame.

5. The loading device of claim 4, wherein the retractable barrier is removably connectable to the lift platform.

6. The loading device of claim 1, further comprising a winder for winding and unwinding the retractable barrier.

7. The loading device of claim 6, wherein the winder comprises a hollow tube having first and second end caps, and a spring-loaded drive mechanism mounted to the end caps.

8. The loading device of claim 1, wherein the retractable barrier comprises a mesh or net.

9. The loading device of claim 1, wherein the retractable barrier comprises yarn, wire or rope.

10. The loading device of claim 1, further comprising a switch for shutting down the loading device if the retractable barrier becomes disengaged from one of the support frame and the lift platform.

11. The loading device of claim 1, wherein the retractable barrier is positionable adjacent a hazard zone within a perimeter of the loading device.

12. The loading device of claim 11, wherein the retractable barrier is positionable outside of the hazard zone.

13. The loading device of claim 11, wherein the retractable barrier is positionable inside of the hazard zone.

14. A loading device, comprising:
a support frame having a front edge, an end edge and two side edges;
a lifting mechanism connected to the support frame;
a movable lift platform having a front edge, an end edge and two side edges; and
a retractable barrier mounted to at least one of the edges of the lift platform, and adapted for releasable connection to a corresponding edge of the support frame.

15. The loading device of claim 14, wherein the retractable barrier is mounted to the end edge of the lift platform.

16. The loading device of claim 14, further comprising a retractable barrier mounted to at least one side edge of the lift platform.

17. The loading device of claim 14, wherein the retractable barrier is mounted to at least one side edge of the lift platform.

18. The loading device of claim 17, further comprising a retractable barrier mounted to the end edge of the lift platform.

19. The loading device of claim 14, wherein the lifting mechanism comprises first scissors mounted to a first side edge of the support frame and second scissors mounted to a second side edge of the support frame.

20. A loading device, comprising:
a support frame;
a movable lift platform;
scissors engaging the support frame and the lift platform for moving the lift platform relative to the support frame;
a stationary operating platform including an operating station; and
at least one retractable barrier mounted to at least one of the lift platform and the support frame, and adapted to engage the other of the lift platform and the support frame.

21. The loading device of claim 20, wherein the operating platform and lift platform are coplanar when the lift platform is in a raised position.

22. The loading device of claim 20, comprising a plurality of the retractable barriers.

23. The loading device of claim 20, further comprising a winder mounted to at least one of the lift platform and the support frame, for winding and unwinding each retractable barrier.
